(19) United States
(12) Patent Application Publication
(10) Pub. No.: US 2024/0107565 A1
(43) Pub. Date: Mar. 28, 2024

(54) METHOD AND SYSTEM FOR OPTIMIZING ENERGY USING TRAFFIC PATTERNS

(71) Applicant: RAKUTEN MOBILE, INC., Tokyo (JP)

(72) Inventor: Krishnakumar KESAVAN, San Mateo, CA (US)

(73) Assignee: RAKUTEN MOBILE, INC., Tokyo (JP)

(21) Appl. No.: 18/013,437

(22) PCT Filed: Nov. 15, 2022
(86) PCT No.: PCT/US2022/049896

§ 371 Date: Dec. 28, 2022

Related U.S. Application Data
(60) Provisional application No. 63/314,473, filed on Feb. 27, 2022.

(51) Int. Cl. H04W 72/52; H04L 41/147; H04L 41/16; H04W 24/02; H04W 28/02; H04W 72/04

(52) U.S. Cl. CPC H04W 72/52; H04L 41/147; H04L 41/16; H04W 24/02; H04W 28/02; H04W 72/04

(57) ABSTRACT

A method and system for optimizing energy using traffic patterns within a network is disclosed. The method can include receiving first identification data with respect to one or more user devices and receiving second identification data with respect to one or more cell sites, wherein the second identification data is based on the one or more user devices in communication with the one or more cell sites. The method can also include applying a threshold criterion or condition to the received first and second identification data. In addition, the method can include generating a probability of network traffic with respect to each of the one or more cell sites based on the received first and second identification data and applied threshold criterion or condition.

### CROSS-REFERENCE TO RELATED APPLICATION(S)

This application is based on and claims priority from U.S. Provisional Patent Application No. 63/314,743 filed on Feb. 27, 2022, the disclosure of which is incorporated by reference herein in its entirety.

### BACKGROUND

One of the primary requirements of cellular network operators is to ensure that the network is operating at maximum efficiency while minimizing resources used. As a result, cellular network monitoring and optimization is a main component of many modern cellular networks. In order to guarantee the best possible performance to the cellular network subscribers, the network is monitored and periodically optimized so that its resources can be more effectively and efficiently utilized within the core network and/or the Radio Access Network (“RAN”). Typically, network optimization is affected by manually modifying network parameters in the Radio and Core Networks based on information that relates to network performance. Such information is retrieved periodically and analyzed by the Operations and Support System (“OSS”) to derive key performance indicators (“KPIs”) therefrom. Current KPIs include typical system level (e.g., related to user or cell throughputs) and link level (e.g., various transmission error rates) metrics.

Currently, there are systems that map base stations that are located geographically close to each other in order to predict traffic patterns. However, one of the limitations of such systems is that they do not learn network traffic behaviors from similar base stations that are located elsewhere within a RAN. For example, if user equipment or user devices are connecting to cell sites from fast moving trains or cars, then there could be several different neighboring cell sites located on different clusters in the user device's path which are not taken into consideration by conventional systems. In real world applications, only a few cell sites within a cluster may receive high network traffic while others do not. Thus, the chances of performing effective energy orchestration and resource allocation based on cell site traffic are very limited and the static nature of such existing systems cannot adapt to varying network traffic patterns, thereby resulting in highly inefficient energy consumption for network operators.

Hence, what is needed is a more efficient method and system for utilizing network traffic path information from neighboring cell sites to predict accurate traffic flow and network usage between cell sites in order to better allocate network resources in order to improve energy savings and efficiency for network elements operating or managing those cell sites within the network.

### SUMMARY

According to example embodiments, a network traffic pattern recognition and dynamic resource allocation method and system are disclosed for utilizing network traffic path information from neighboring cell sites to predict accurate traffic flow patterns and network usage between cell sites in order to better allocate network resources in order to improve energy savings and efficiency for network elements operating or managing those cell sites within the network. In other example embodiments, a network traffic pattern recognition and dynamic resource allocation method and system is disclosed to identify base stations or cell sites based on the traffic patterns of user devices in order to perform energy orchestration and dynamic resource allocation. In some embodiments, the foregoing can be achieved by creating a plurality of cell site clusters, taking inputs from user traffic patterns over several observations, then creating a neural network (“NN”) based server embeddings and using the embeddings to predict traffic patterns, and further proactively modulate the sleep and awake patterns of the servers. Here, the method and system of the disclosure described herein is adaptive and can evolve with new cell site traffic patterns. In addition, the cell site clustering based on the user traffic can be generated automatically and without human intervention. In addition, the method and system of the disclosure described herein can enhance energy orchestration resulting in higher savings by predicting network traffic before it actually reaches a cell site and evaluating how traffic flows through any one or more cell sites or base stations, thereby minimizing processing times, workload, and operations of network elements.

According to other example embodiments, a method of optimizing energy using traffic patterns within a network is disclosed. The method can include receiving first identification data with respect to one or more user devices; receiving second identification data with respect to one or more cell sites, wherein the second identification data is based on the one or more user devices in communication with the one or more cell sites; applying a threshold criterion or condition to the received first and second identification data; and generating a probability of network traffic with respect to each of the one or more cell sites based on the received first and second identification data and applied threshold criterion or condition.

In addition, the method may include grouping the first and second identification data with respect to one or more times of day, time period, or time range.

Further, wherein the step of generating a probability of network traffic with respect to each of the one or more cell sites may be further based on a defined time of day, time period, or time range.

Also, the step of generating a probability of network traffic with respect to each of the one or more cell sites may be further based on neural network embeddings.

Moreover, the method may include obtaining a vector of one or more numbers to represent each of the one or more cell sites.

In addition, the method may include generating a cluster for the numeric representation of each of the one or more cell sites.

Further, the method may include determining a travel path for the one or more user devices based on the generated probability of network traffic with respect to each of the one or more cell sites.

Also, the method may include generating a grouping or clustering of one or more cell sites within a travel path of the one or more user devices based on the generated probability of network traffic with respect to each of the one or more cell sites.

In addition, the method may include allocating network resources to each of the one or more cell sites based on the generated probability of network traffic with respect to each of the one or more cell sites.

Further, the step of allocating network resources to each of the one or more cell sites may also include managing operational times of one or more servers in communication with the one or more cell sites.

In other example embodiments, an apparatus for optimizing energy using traffic patterns within a network is disclosed, including a memory storage storing computer-executable instructions; and a processor communicatively coupled to the memory storage, wherein the processor is configured to execute the computer-executable instructions and cause the apparatus to receive first identification data with respect to one or more user devices; receive second identification data with respect to one or more cell sites, wherein the second identification data is based on the one or more user devices in communication with the one or more cell sites; apply a threshold criterion or condition to the received first and second identification data; and generate a probability of network traffic with respect to each of the one or more cell sites based on the received first and second identification data and applied threshold criterion or condition.

In addition, wherein the computer-executable instructions, when executed by the processor, may further cause the apparatus to group the first and second identification data with respect to one or more times of day, time period, or time range.

Further, the step of generating a probability of network traffic with respect to each of the one or more cell sites may be further based on a defined time of day, time period, or time range.

Also, the step of generating a probability of network traffic with respect to each of the one or more cell sites may be further based on neural network embeddings.

Moreover, the computer-executable instructions, when executed by the processor, may further cause the apparatus to obtain a vector of one or more numbers to represent each of the one or more cell sites.

In addition, the computer-executable instructions, when executed by the processor, may further cause the apparatus to generate a cluster for the numeric representation of each of the one or more cell sites.

Further, the computer-executable instructions, when executed by the processor, may further cause the apparatus to determine a travel path for the one or more user devices based on the generated probability generating a probability of network traffic with respect to each of the one or more cell sites.

Also, the computer-executable instructions, when executed by the processor, may further cause the apparatus to generate a grouping or clustering of one or more cell sites within a travel path of the one or more user devices based on the generated probability of network traffic with respect to each of the one or more cell sites.

Moreover, the computer-executable instructions, when executed by the processor, may further cause the apparatus to allocate network resources to each of the one or more cell sites based on the generated probability of network traffic with respect to each of the one or more cell sites.

In other example embodiments, a non-transitory computer-readable medium comprising computer-executable instructions for optimizing energy using traffic patterns within a network by an apparatus, wherein the computer-executable instructions, when executed by at least one processor of the apparatus, cause the apparatus to receive first identification data with respect to one or more user devices; receive second identification data with respect to one or more cell sites, wherein the second identification data is based on the one or more user devices in communication with the one or more cell sites; apply a threshold criterion or condition to the received first and second identification data; and generate a probability of network traffic with respect to each of the one or more cell sites based on the received first and second identification data and applied threshold criterion or condition.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of a general system architecture of the network traffic pattern recognition method and system of the disclosure described herein according to one or more exemplary embodiments;

FIG. 2 illustrates a simplified top view of a map of cell sites within a network for the network traffic pattern recognition method and system of the disclosure described herein according to one or more exemplary embodiments;

FIG. 3 illustrates another simplified top view of a geographic map of cell sites within a network for the network traffic pattern recognition method and system of the disclosure described herein, shown with dynamic cell site clusters based on traffic patterns between cell sites, according to one or more exemplary embodiments;

FIG. 4 illustrates another simplified top view of a geographic map of cell sites within a network for the network traffic pattern recognition method and system of the disclosure described herein, shown with dynamic cell site clusters based on traffic patterns between cell sites and travel paths of user devices within each cluster, according to one or more exemplary embodiments;

FIG. 5 illustrates another simplified top view of a geographic map of cell sites within a network for the network traffic pattern recognition method and system of the disclosure described herein, shown with an alternative dynamic cell site cluster based on new traffic patterns between cell sites and new travel path of user devices within the alternative cell site cluster, according to one or more exemplary embodiments; and

FIG. 6 illustrates a flowchart for the network traffic pattern recognition method and system of the disclosure described herein according to one or more exemplary embodiments.

### DETAILED DESCRIPTION

The following detailed description of example embodiments refers to the accompanying drawings. The same reference numbers in different drawings may identify the same or similar elements.

The foregoing disclosure provides illustrations and descriptions, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of an example embodiment, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

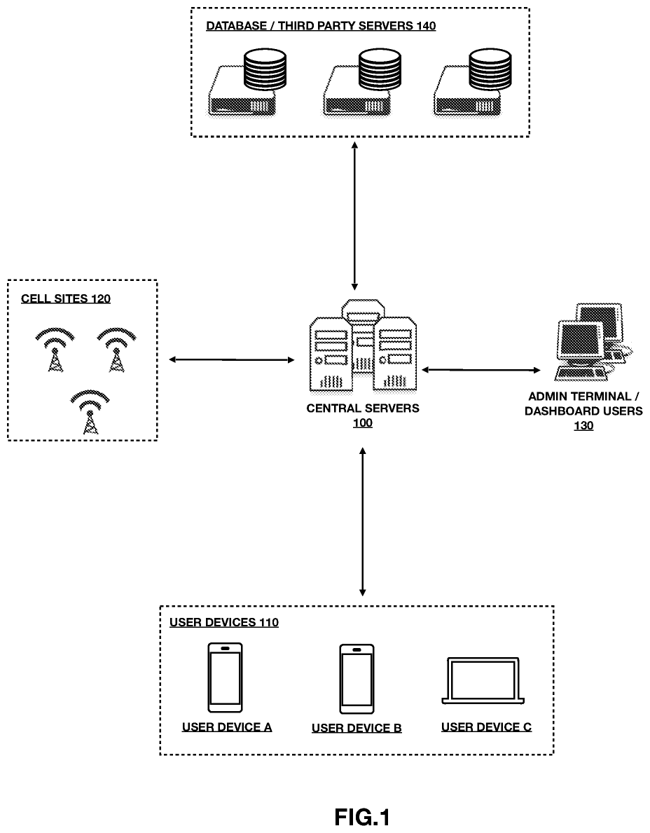

FIG. 1 illustrates a diagram of a general network architecture according to one or more embodiments. Referring to FIG. 1, user devices 110, base stations/cell sites 120, and admin terminal/dashboard users 130 can be in bi-directional communication over a secure network with central servers or application servers 100 according to one or more embodiments. In addition, components 110, 120, 130 may also be in direct bi-directional communication with each other via the network system of the disclosure described herein according to one or more embodiments. Here, user devices 110 can be any type of user equipment (UE) and customer of a network or telecommunication service provider, such as users operating computing user devices A, B, and C. Each of user device 110 can communicate with servers 100 via their respective terminals or portals. The user devices 110 may communicate with servers 100 via the cell sites 120 or a different communication connection (e.g., Wi-Fi, Ethernet, etc.). Cell sites 120 can include any type and number of cell sites, base stations, cell towers, radios, femtocells, and the like (including any servers that operate or manages each cell site) of the network service provider for providing wireless network access and services to any users of user devices 110. Admin terminal or dashboard 130 may include any type of user with access privileges for accessing a dashboard or management portal of the disclosure described herein, wherein the dashboard portal can provide various user tools, maps, resource allocation, energy orchestration, and customer support options. It is contemplated within the scope of the present disclosure described herein that any user of user devices 110 may also access the admin terminal or dashboard 130 of the disclosure described herein.

Still referring to FIG. 1, central servers 100 of the disclosure described herein according to one or more embodiments can be in further bi-directional communication with database/third party servers 140, which may also include users. Here, servers 140 can include vendors and databases where various captured, collected, or aggregated data from cells sites 120 and/or user devices 110 may be uploaded thereto or stored thereon and retrieved therefrom for network analysis and neural network (NN), machine learning, and artificial intelligence (AI) processing by servers 100. However, it is contemplated within the scope of the present disclosure described herein that the network traffic pattern recognition method and system of the disclosure described herein can include any type of general network architecture.

Still referring to FIG. 1, one or more of servers or terminals of elements 100-140 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 100-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a transmitter component, and/or a transceiver component. The communication interface may enable one or more of servers or terminals of elements 100-140 to establish connections and/or transfer communications with other devices (e.g., a server, another device). The communications may be enabled via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like. In the embodiments, any one of the operations or processes of the figures may be implemented by or using any one of the elements disclosed herein. It is understood that other embodiments are not limited thereto, and may be implemented in a variety of different architectures (e.g., bare metal architecture, any cloud-based architecture or deployment architecture such as Kubernetes, Docker, OpenStack, etc.)

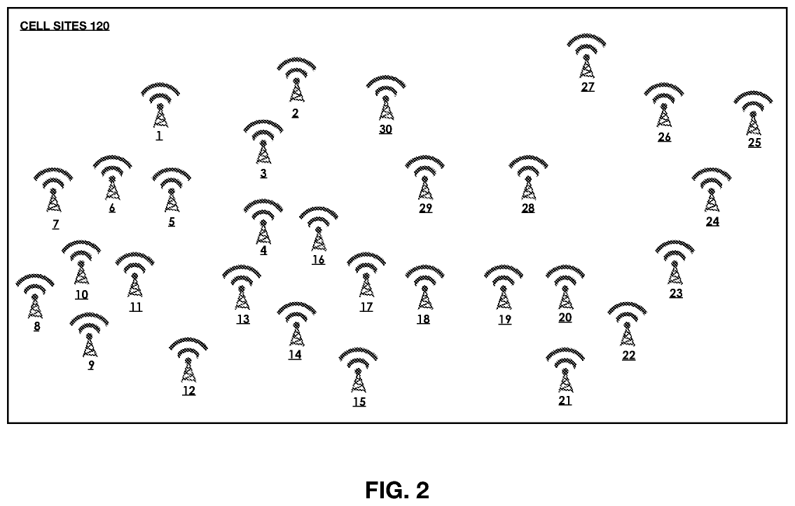

FIG. 2 illustrates a simplified top view of a map of various cell sites 120 within a network for the network traffic pattern recognition method and system of the disclosure described herein, according to one or more exemplary embodiments. In particular, cells sites 120 can include base stations 1-30, radio towers 1-30, or cells site 1-30 dispersed in various geographic regions, such as within a state, city, suburb, or district. Further, each cell site 1-30 may also be near a road, rail, trail, or travel path whereby a user of a user device may travel therethrough. In addition, each cell site 1-30 may be operated and/or managed via one or more servers or various network components and elements, such as network switches or routers.

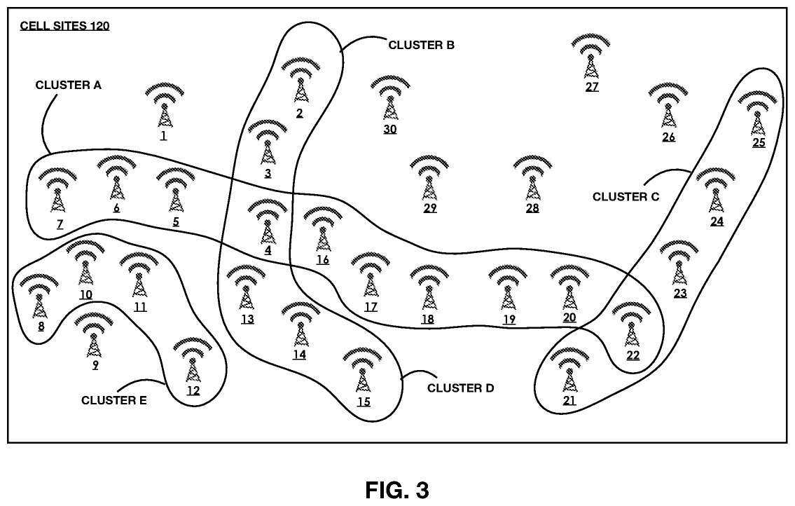

FIG. 3 illustrates another simplified top view of a map of various cell sites 120 within a network for the network traffic pattern recognition method and system of the disclosure described herein, according to one or more exemplary embodiments. Here, certain cell sites can form a group or cluster that represents network high traffic cell sites or cell sites that will receive higher than normal predicted network traffic based on the time of day, time period, or time range in which user devices are connecting and communicating with those cell sites. For example, cell sites 2, 3, 4, 13, 14, and 15 (including neighboring/adjacent cell sites) may be part of a group or Cluster B having a high probability of receiving higher than normal network traffic during a specific time of day, time period, or time range (e.g., 3 pm-6 pm on Mondays) based on a neural network (NN) embedding modeling, AI, or machine learning of the disclosure described herein. Accordingly, the cell sites (including neighboring/adjacent cell sites) within Cluster B would be allocated higher energy resources, while cell sites (including neighboring/adjacent cell sites) that have a lower probability of network traffic have their energy consumption reduced, such as inactive or low network traffic cell sites 1, 9, and 26-30. Accordingly, the method and system of the disclosure described herein can dynamically perform energy orchestration and resource allocation in advance for individual cell sites (including primary cell sites and their neighboring cell sites) depending on the predicted usage or network traffic for such sites during a given time of day or a time period range prior to the cell sites receiving such network traffic.

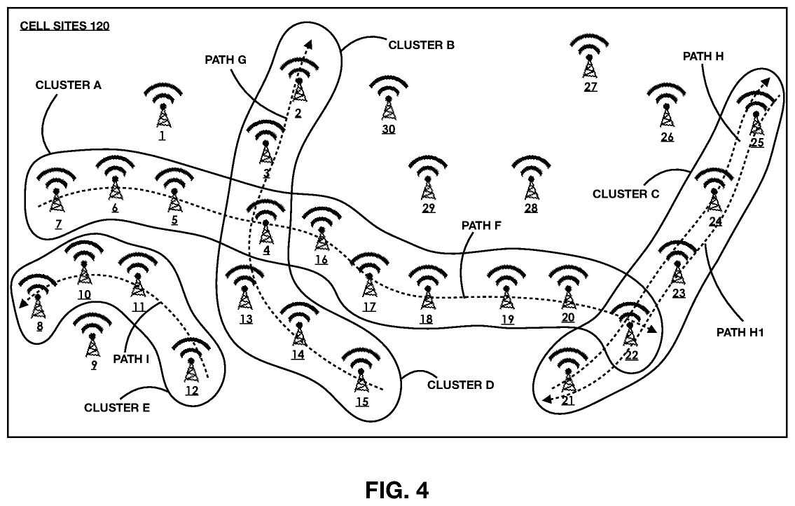

FIG. 4 illustrates another simplified top view of a map of various cell sites 120 within a network for the network traffic pattern recognition method and system of the disclosure described herein, according to one or more exemplary embodiments. Here, certain cell sites can form a group or cluster that represent network high traffic cell sites or cell sites that will receive higher than normal predicted network traffic (or high utilization) based on the time of day or time period in which user devices are connecting and communicating with those cell sites. In particular, FIG. 4 also illustrates a direction or path for one or more user devices within a particular group or cluster of cell sites. For example, as shown in FIG. 4, one or more user devices may travel in one direction, such as Path G within Cluster B, and one or more devices may travel in another direction, such as Path I within Cluster E. Here, the method and system of the disclosure described herein can dynamically adapt and the predict probability of network traffic for each cell site from its NN, AI, or machine learning model that includes either the path to a destination or from the destination.

Still referring to FIG. 4, for example, the NN model of the disclosure described herein may output a probability of 0.8 or 80% that cell site 17 (within Cluster A) will be utilized as opposed to a 0.1 or 10% probability that cell site 29 will be utilized for a given time period. Similarly, neighboring cell sites to that of cell site 17, may also have increased probabilities of usage or network traffic, such as 90% for neighboring cell site 18 in a prior known path of a user device. Accordingly, the system can dynamically allocate 80% power or energy usage to cell site 17 (or a server managing cell site 17) and 10% power or energy usage to cell site 29 (or a server managing cell site 29), thereby resulting in very efficient energy usage and energy savings for the network. As previously disclosed, cell sites within a travel path of a user device to and from a destination (roundtrip) can also be accounted for. For example, this can include a user device traveling from a home location to a work location during one time period (e.g., Path H within Cluster C), and then traveling from the work location to a home location during another time period (e.g., Path H1 within Cluster C), and all of the cell sites that the user device connected to in its path during the entire roundtrip (e.g., cell sites 21-25).

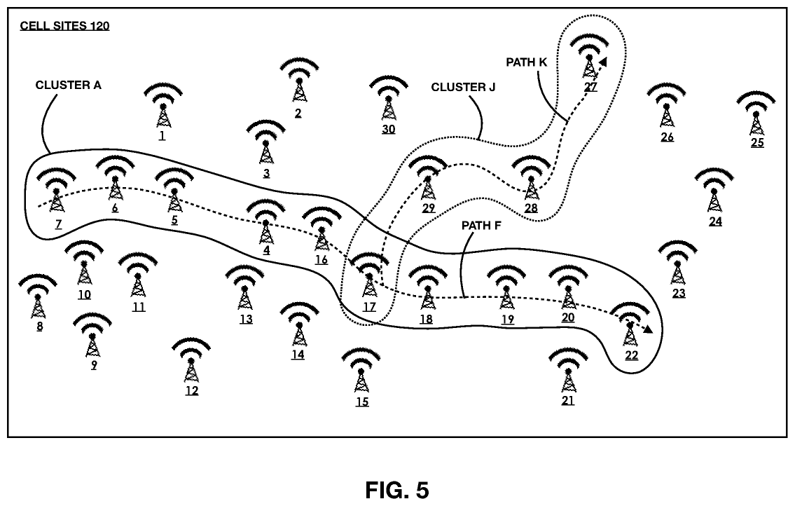

FIG. 5 illustrates another simplified top view of a map of various cell sites 120 within a network for the network traffic pattern recognition method and system of the disclosure described herein, according to one or more exemplary embodiments. Here, certain cell sites can form a group or cluster that represents network high traffic cell sites or cell sites that will receive higher than normal predicted network traffic based on the time of day or time period in which user devices are connecting and communicating with those cell sites. In particular, FIG. 5 also illustrates an alternative or new path a user device may take from a prior known path in which the NN model, AI, and machine learning method and system of the disclosure described herein can account for. For example, as shown in FIG. 5, one or more user devices may travel in one direction, such as via Path F within Cluster B, but then alternatively diverge therefrom or form a new path along another set of cell sites, such as via Path K within Cluster J. In such a scenario, the system and method of the disclosure described herein may re-allocate energy resources that were previously allocated to cell sites 18, 19, 20, and 22 along Path F to cell sites 29, 28, and 27 along the new Path K within new Cluster J. Accordingly, the NN model, AI, and machine learning method and system of the disclosure described herein can be dynamically and continuously trained and re-trained to learn the one or more user devices new alternative paths in order to provide and predict more accurate probabilities with respect to network traffic and cell site utilization.

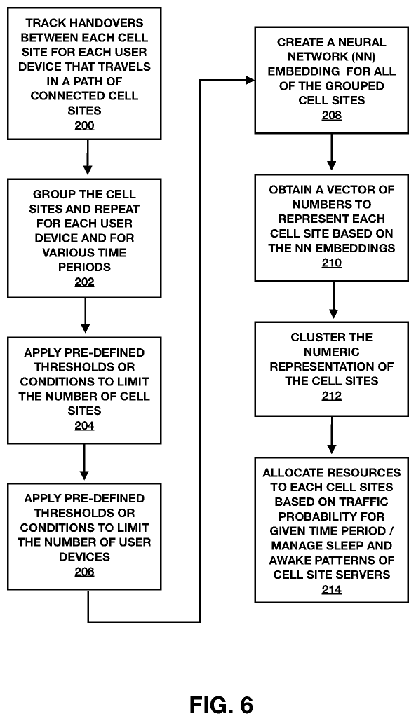

FIG. 6 illustrates a process flow for the network traffic pattern recognition and dynamic resource allocation method and system of the disclosure described herein, according to one or more exemplary embodiments. At step 200, the process can begin by tracking handovers between cell sites for each user device that is travelling in a path (such as via road, rail, air, etc.), wherein each user device connects to the cell sites on that path. For example, such as shown in FIG. 5 in one exemplary embodiment, a user device may travel along a Path F, whereby it connects and creates handovers between each cell sites 7, 6, 5, 4, 16, 17, 18, 19, 20, and 22 within Cluster A. Here, at step 200, the system of the disclosure described herein can receive and obtain data for each user device identification (ID), cell site identification (ID), and the time of day the specific user device connected to a particular cell site, such as a user device connecting to cell cite 16 at a specific time and date along Path F, as shown in FIG. 5. From the collected data, the system can determine certain traffic patterns for cell sites within the network for each user device.

Still referring to FIG. 6, at step 202, the process can group the cell sites receiving network traffic and perform the grouping for each user device that connects to the cell sites within the network. Next, at step 204, the process can apply certain pre-defined thresholds criterions or conditions to filter, refine, and limit the number of cell sites within the list. Next, at step 206, the process can also apply certain pre-defined threshold criterions or conditions to filter, refine, and limit the number of user devices. In particular, referring to steps 202-206, for every trip of each user device ID, the system creates a list of all cell site IDs that were in the path of a user device ID. Next, certain thresholds and conditions may be applied to the list to filter it for more relevance, accuracy, and provide the minimum number of cell sites within a user device's path. Next, from the filtered list, all the cell site ID's that were in the path of any of the user devices ID's are grouped together. For example, a first group may be created for all of the cell sites in communication with user device A, and a second group for all of the cell sites in communication with user device B. In addition, each group may include overlapping cell site IDs which may be used by different user device IDs.

Still referring to FIG. 6, at step 208, the process can create a NN embedding model for all of the grouped cell sites. In particular, the algorithm of the disclosure described herein can builds a two-layer neural network that processes a user device ID's journey by vectorizing the cell site ID's. Here, the input of the NN embedding model can be a user device ID's journey or path, wherein its output can be a set of vectors. At step 210, the process can obtain a vector of values or numbers to represent each cell site based on the NN embeddings. Next, at step 212, the process can cluster the value or numeric representation of cell sites. Specifically, the cell sites that are closer to the other cell sites (such as neighboring cell sites) in any user devices path or journey are embedded closer to each other within the NN embedding. Such NN embedding of (such as of closest neighboring cell sites) may also be visually represented on a map.

In other embodiments, the NN model, AI, or machine learning method and system of the disclosure described herein may assign certain higher or lower weights to certain cell sites to achieve improved probability with respect to network traffic. Here, the NN embedding model can further provide, as output, probabilities with respect to network traffic and/or cell site utilization for a specific time of day, time period, or time range. At step 214, such probabilities may be used by the method and system of the disclosure described herein to perform energy orchestration and dynamically allocate energy and network resources to each cell site for a specific time, a time period, multiple time periods, time ranges, or based on a dynamically adjustable schedule. For example, this can include automatically allocating higher power and energy resources to highly utilized cell sites and lower power and energy resources to lower utilized cell sites. This can also include automatically managing and operating wake, sleep, and operating times for certain servers, computing devices, network routers, network switches, network elements, and various network resources associated with certain cell sites in order to optimize energy usage within the network.

In other embodiments, any of the foregoing discussions may be represented on a graphical user interface (GUI), such as within dashboard or portal. For example, a GUI may display the clusters of cell sites and the paths of user devices within the network, such as shown in FIGS. 3-5. In addition, a user may be able to visually see future energy usage and consumption based on prior known traffic patterns, and further provide the ability of network operators to better manage their cell site networks during peak or low demand times and further better predict future network infrastructure needs to meet demands for certain traffic patterns for its subscriber network.

It is understood that the specific order or hierarchy of blocks in the processes/ flowcharts disclosed herein is an illustration of example approaches. Based upon design preferences, it is understood that the specific order or hierarchy of blocks in the processes/ flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of optimizing energy using traffic patterns within a network, the method comprising:
receiving first identification data with respect to one or more user devices;
receiving second identification data with respect to one or more cell sites, wherein the second identification data is based on the one or more user devices in communication with the one or more cell sites;
applying a threshold criterion or condition to the received first and second identification data; and
generating a probability of network traffic with respect to each of the one or more cell sites based on the received first and second identification data and applied threshold criterion or condition.

2. The method of claim 1, further comprising:
grouping the first and second identification data with respect to at least one of one or more times of day, time period and time range.

3. The method of claim 1, wherein the step of generating a probability of network traffic with respect to each of the one or more cell sites is further based on a defined time of day, time period, or time range.

4. The method of claim 1, wherein the step of generating a probability of network traffic with respect to each of the one or more cell sites is further based on neural network embeddings.

5. The method of claim 4, further comprising:
obtaining a vector of one or more numbers to represent each of the one or more cell sites.

6. The method of claim 4, further comprising:
generating a cluster for the numeric representation of each of the one or more cell sites.

7. The method of claim 1, further comprising:
determining a travel path for the one or more user devices based on the generated probability of network traffic with respect to each of the one or more cell sites.

8. The method of claim 1, further comprising:
generating a grouping or clustering of one or more cell sites within a travel path of the one or more user devices based on the generated probability of network traffic with respect to each of the one or more cell sites.

9. The method of claim 1, further comprising:
allocating network resources to each of the one or more cell sites based on the generated probability of network traffic with respect to each of the one or more cell sites.

10. The method of claim 9, wherein the step of allocating network resources to each of the one or more cell sites further comprising managing operational times of one or more servers in communication with the one or more cell sites.

11. An apparatus for optimizing energy using traffic patterns within a network, comprising:
a memory storage storing computer-executable instructions; and
a processor communicatively coupled to the memory storage, wherein the processor is configured to execute the computer-executable instructions and cause the apparatus to:
receive first identification data with respect to one or more user devices;
receive second identification data with respect to one or more cell sites, wherein the second identification data is based on the one or more user devices in communication with the one or more cell sites;
apply a threshold criterion or condition to the received first and second identification data; and
generate a probability of network traffic with respect to each of the one or more cell sites based on the received first and second identification data and applied threshold criterion or condition.

12. The apparatus of claim 11, wherein the computer-executable instructions, when executed by the processor, further cause the apparatus to:
group the first and second identification data with respect to one or more times of day, time period, or time range.

13. The apparatus of claim 11, wherein the step of generating a probability of network traffic with respect to each of the one or more cell sites is further based on a defined time of day, time period, or time range.

14. The apparatus of claim 11, wherein the step of generating a probability of network traffic with respect to each of the one or more cell sites is further based on neural network embeddings.

15. The apparatus of claim 14, wherein the computer-executable instructions, when executed by the processor, further cause the apparatus to:
obtain a vector of one or more numbers to represent each of the one or more cell sites.

16. The apparatus of claim 14, wherein the computer-executable instructions, when executed by the processor, further cause the apparatus to:
generate a cluster for the numeric representation of each of the one or more cell sites.

17. The apparatus of claim 11, wherein the computer-executable instructions, when executed by the processor, further cause the apparatus to:
determine a travel path for the one or more user devices based on the generated probability of network traffic with respect to each of the one or more cell sites.

18. The apparatus of claim 11, wherein the computer-executable instructions, when executed by the processor, further cause the apparatus to:
generate a grouping or clustering of one or more cell sites within a travel path of the one or more user devices based on the generated probability of network traffic with respect to each of the one or more cell sites.

19. The apparatus of claim 11, wherein the computer-executable instructions, when executed by the processor, further cause the apparatus to:
allocate network resources to each of the one or more cell sites based on the generated probability of network traffic with respect to each of the one or more cell sites.

20. A non-transitory computer-readable medium comprising computer-executable instructions for optimizing energy using traffic patterns within a network by an apparatus, wherein the computer-executable instructions, when executed by at least one processor of the apparatus, cause the apparatus to:
receive first identification data with respect to one or more user devices;
receive second identification data with respect to one or more cell sites, wherein the second identification data is based on the one or more user devices in communication with the one or more cell sites;
apply a threshold criterion or condition to the received first and second identification data; and
generate a probability of network traffic with respect to each of the one or more cell sites based on the received first and second identification data and applied threshold criterion or condition.
